(19) United States
(12) Patent Application Publication
(10) Pub. No.: US 2009/0130538 A1
(43) Pub. Date: May 21, 2009

(54) Battery Apparatus, Vehicle Having the Same Mounted Thereon, and Failure Determining Method for the Battery Apparatus

(75) Inventors: Keiji Kaita, Nishikamo-gun (JP); Teruo Ishishita, Nishikamo-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/226,974

(22) PCT Filed: May 10, 2007
(86) PCT No.: PCT/JP2007/059659

§ 371 Date: Nov. 3, 2008

(30) Foreign Application Priority Data
May 16, 2006 (JP) 2006-136559

(51) Int. Cl. H01M 2/00; H01M 10/44

(52) U.S. Cl. 429/50; 429/61

(57) ABSTRACT

The high-voltage battery unit 400, for each of the plurality of areas A1 to AN grouped by the temperature distribution pattern set in step S110, the reference internal resistance Rrc(n) indicating an internal resistance of the battery cell 450 based on the correlation to the temperature is acquired based on the area representative temperature Ta(n) detected by any one of the temperature sensors 44k in the individual area An (step S140); the detected internal resistance Rdm(m) based on the detected voltage V(x) and the detected current value I is acquired for each battery module 40x; the presence or absence of an abnormal cell in an individual battery module 40x is determined based on the reference internal resistance Rrm(n) of the battery module 40x based on the reference internal resistance Rrc(n) and the detected internal resistance Rdm(m) (steps S180 to S210).

### TECHNICAL FIELD

The present invention relates to a battery apparatus, a vehicle having the same mounted thereon, and an failure determining method for the battery apparatus, and more particularly, to a battery apparatus provided with a plurality of battery cells having an internal resistance varying depending on an individual temperature thereof, a vehicle having the same mounted thereon, and a failure determining method for the battery apparatus.

### BACKGROUND ART

Conventionally, as a battery apparatus including a serially connected plurality of battery blocks, there has been known a battery apparatus which obtains an internal resistance of an individual battery block based on a voltage of the battery block and a battery current, and detects an abnormal temperature rise of a single battery (battery cell) constituting an individual battery block based on the obtained internal resistance of the battery block and a predetermined threshold (see, for example, Patent Document 1). In addition, as such a battery apparatus, there has also been known a battery apparatus which obtains an internal resistance of a battery from the battery current and a value acquired by subtracting, from the battery voltage, the battery open voltage calculated based on the SOC (state of charge) of the battery and the like; and determines a battery deterioration state by comparing the obtained internal resistance and the battery initial resistance based on the battery temperature (see, for example, Patent Document 2).

[Patent Document 1] Japanese Patent Laid-Open No. 2001-196102

[Patent Document 2] Japanese Patent Laid-Open No. 2004-271410

### DISCLOSURE OF THE INVENTION

By the way, some battery cells (unit batteries) constituting the battery apparatus have a relatively small internal resistance and vary relatively largely depending on a cell temperature. For example, such a battery cell has a small difference between the internal resistance of a normal cell at low temperatures and the internal resistance of an abnormal cell at ordinary temperatures. For this reason, in the case of such a battery apparatus provided with a plurality of battery cells each having an internal resistance highly depending on a temperature, if the cell temperature is not considered, even the use of the internal resistance of the battery block acquired by actual measurement values of the voltage and the current runs the risk of being incapable of accurately determining a failure of a battery cell. However, installing a temperature sensor for each battery cell has a problem in terms of cost, reliability, mounting space, and the like.

In view of this, an object of the battery apparatus, the vehicle having the same mounted thereon, and the failure determining method for the battery apparatus in accordance with the present invention is to accurately determine the failure of a battery cell using a smaller number of temperature detection modules in a battery apparatus provided with a plurality of battery cells each having an internal resistance varying depending on an individual temperature thereof. Another object of the battery apparatus, the vehicle having the same mounted thereon, and the failure determining method for the battery apparatus in accordance with the present invention is to improve the failure determination accuracy for a battery cell.

In order to achieve at least one of the above described objects, a vehicle and a control method therefor in accordance with the present invention adopts the following means.

The present invention is directed to a first battery apparatus including a plurality of battery cells each having an internal resistance varying depending on a temperature. The battery apparatus includes: a plurality of temperature detection devices arranged for the plurality of battery cells; a voltage detection device for detecting a voltage of each of a plural cell blocks each composed of at least one battery cell; a current detection device for detecting a current flowing through each of the cell blocks; a detected internal resistance acquisition module for acquiring a detected internal resistance indicating an internal resistance of the cell block based on the detected voltage and the detected current; a reference internal resistance acquisition module for acquiring a reference internal resistance indicating an internal resistance of the battery cell based on a correlation to a temperature in each of a plurality of areas grouped so as to contain at least one battery cell and one temperature detection device according to a predetermined constraint, based on the temperature detected by any one of the temperature detection devices in the area; and a failure determination module for determining a failure of the battery cell based on the acquired detected internal resistance and the acquired reference internal resistance.

According to the first battery apparatus, the detected internal resistance indicating an internal resistance of the cell block based on the detected voltage and the detected current is acquired for each of the plurality of cell blocks each composed of at least one battery cell; the reference internal resistance indicating an internal resistance of the battery cell based on a correlation to a temperature is acquired for each of the plurality of areas grouped so as to contain at least one pair of the battery cells and the temperature detection modules according to a predetermined constraint, based on the temperature detected by any one of the temperature detection modules in an individual area; and a failure of the battery cell is determined based on the acquired detected internal resistance and the reference internal resistance. As described above, a temperature detected by any one of the temperature detection modules in an individual area is treated as a representative temperature of the battery cell in the area; a comparison is made between the reference internal resistance acquired based on the representative temperature and the detected internal resistance based on the detected voltage and the detected current; and this eliminates the need to install a temperature detection module in every battery cell; and thus a smaller number of temperature detection modules can be used to accurately determine a failure of the battery cell having an internal resistance varying depending on the temperature.

In addition, according to the first battery apparatus in accordance with the present invention, the predetermined constraint may be a constraint based on a temperature distribution in the plurality of battery cells for grouping the plurality of battery cells into areas so as to contain the battery cell in an isothermal region within one of the areas. If a plurality of battery cells are grouped into areas using such a constraint, the reference internal resistances of the individual battery cells in one area can be considered to be substantially the same. Therefore, the reference internal resistance acquired based on the temperature (representative temperature) detected by any one of the temperature detection modules in an individual area can be more proper and the failure determination accuracy of the battery cell can be improved. It should be noted that, here, “isothermal region” is specified according to the degree of temperature dependence of the internal resistance of the battery cell, and thus, it is not essential that the internal resistances of the individual battery cells must be within a strict temperature range as long as the internal resistances thereof in one area are approximately equal.

Further, the first battery apparatus in accordance with the present invention may further include a temperature distribution pattern storage module for storing a plurality of temperature distribution patterns in the plurality of battery cells as the predetermined constraint according to an operating environment of the battery apparatus; and an environmental information acquisition module for acquiring environmental information related to the operating environment, wherein the reference internal resistance acquisition module may be configured such that, based on a temperature distribution pattern corresponding to at least the acquired environmental information in the temperature distribution patterns stored by the temperature distribution pattern storage module, the cell block contained in the areas corresponding to a plurality of temperature detection modules used for failure determination of the battery cell and each of the plurality of temperature detection modules is identified; and the reference internal resistance of the cell block is acquired for each of the plurality of areas. That is, the temperature distribution in a plurality of battery cells changes according to the operating environment of the battery apparatus. Therefore, when a plurality of temperature distribution patterns are stored according to the operating environment of the battery apparatus, and a plurality of battery cells are grouped into areas based on the temperature distribution patterns according to the operating environment of the battery apparatus, the reference internal resistance acquired based on the temperature (representative temperature) detected by any one of the temperature detection modules in an individual area can be constantly more proper and a failure of the battery cell can be determined more accurately. It should be noted that the examples of the environmental information related to the operating environment of the battery apparatus include a temperature in the vicinity of the battery apparatus and a cooling state by a cooling module of the battery apparatus.

In addition, the first battery apparatus in accordance with the present invention may further include: a battery representative temperature detection device for detecting a representative temperature of the battery apparatus; and a module for determining a failure of the temperature detection device by comparing between a temperature detected by the individual temperature detection device and a temperature detected by the battery representative temperature detection module.

Further, the first battery apparatus in accordance with the present invention may further include a temperature distribution estimation module for estimating a temperature distribution in the plurality of battery cells based on an operating state of the battery apparatus; and a module for determining a failure of the individual temperature detection module based on a temperature detected by the individual temperature detection module and the estimated temperature distribution. This allows a failure of the individual temperature detection module to be accurately detected, thereby improving the reliability of the values detected by the temperature detection module as well as the reliability of the failure determination of the battery cell.

In addition, in the first battery apparatus in accordance with the present invention, the battery cell may be configured as a lithium secondary battery or a nickel-metal hydride battery.

The present invention is directed to a first vehicle with a battery apparatus mounted thereon. The battery apparatus includes a plurality of battery cells each having an internal resistance varying depending on a temperature. The vehicle includes: a plurality of temperature detection devices arranged for the plurality of battery cells; a voltage detection device for detecting a voltage of each of a plural cell blocks each composed of at least one battery cell; a current detection device for detecting a current flowing through each of the cell blocks; a detected internal resistance acquisition module for acquiring a detected internal resistance indicating an internal resistance of the cell block based on the detected voltage and the detected current; a reference internal resistance acquisition module for acquiring a reference internal resistance indicating an internal resistance of the battery cell based on a correlation to a temperature in each of the plurality of areas grouped so as to contain at least one battery cell and one temperature detection device according to a predetermined constraint, based on the temperature detected by any one of the temperature detection devices in the area; and a failure determination module for determining a failure of the battery cell based on the acquired detected internal resistance and the acquired reference internal resistance.

Since the battery apparatus mounted on the first vehicle as the power source can accurately determine a failure of the battery cell having an internal resistance varying depending on the temperature using a smaller number of temperature detection modules, the vehicle can achieve stable driving while more properly monitoring the battery apparatus as the power source.

The present invention is directed to a second battery apparatus including a plurality of battery cells each having an internal resistance varying depending on a temperature. The battery apparatus includes: a plurality of temperature detection devices arranged for the plurality of battery cells; a voltage detection device for detecting a voltage of each of a plural cell blocks each composed of at least one battery cell; a current detection device for detecting a current flowing through each of the cell blocks; a detected internal resistance acquisition module for acquiring a detected internal resistance indicating an internal resistance of the cell block based on the detected voltage and the detected current; a reference internal resistance estimation module for estimating a reference internal resistance indicating an internal resistance of the battery cell based on a correlation to a temperature, based on the temperature detected by the plurality of temperature detection devices; and a failure determination module determining a failure of the battery cell based on the acquired detected internal resistance and the estimated reference internal resistance.

According to the second battery apparatus, the detected internal resistance indicating an internal resistance of the cell block based on the detected voltage and the detected current is acquired for each of the plurality of cell blocks each composed of at least one battery cell; the reference internal resistance indicating the internal resistance of the battery cell based on a correlation to a temperature is estimated based on the temperature detected by the plurality of temperature detection modules; and a failure of the battery cell is determined based on the acquired detected internal resistance and the reference internal resistance. As described above, the reference internal resistance of a battery cell is estimated based on the temperature detected by a plurality of temperature detection modules; a comparison is made between the estimated reference internal resistance and the detected internal resistance based on the detected voltage and the detected current; and this eliminates the need to install a temperature detection module in every battery cell; and thus a smaller number of temperature detection modules can be used to accurately determine a failure of the battery cell having an internal resistance varying depending on the temperature.

In addition, the second battery apparatus in accordance with the present invention may be configured such that the cell block is composed of a serially connected plurality of the battery cells; the reference internal resistance acquisition module estimates an individual temperature of the battery cell based on the temperature detected by the plurality of temperature detection modules; acquires an individual reference internal resistance of the battery cell based on the estimated temperature; and calculates an individual reference internal resistance of the cell block based on the acquired reference internal resistance of the battery cell; the failure determination module determines the presence or absence of an abnormal cell in each of the cell blocks based on the acquired detected internal resistance and the calculated reference internal resistance of the cell block. As described above, the temperature of an individual battery cell is estimated based on the temperature detected by the plurality of temperature detection modules; the reference internal resistance of the individual cell block is calculated from the reference internal resistance of an individual battery cell based on the estimated temperature; and thereby, the reference internal resistance used for failure determination can be more proper and the failure determination accuracy of a battery cell can be improved.

Further, the second battery apparatus in accordance with the present invention may further include: a battery representative temperature detection device for detecting a representative temperature of the battery apparatus; and a module for determining a failure of the individual temperature detection device by comparing between a temperature detected by the temperature detection device and a temperature detected by the battery representative temperature detection module.

In addition, the second battery apparatus in accordance with the present invention may further include: a temperature distribution estimation module for estimating a temperature distribution in the plurality of battery cells based on an operating state of the battery apparatus; and a module for determining a failure of the individual temperature detection module based on a temperature detected by the individual temperature detection module and the estimated temperature distribution.

Further, in the second battery apparatus in accordance with the present invention, the battery cell may be configured as a lithium secondary battery or a nickel-metal hydride battery.

The present invention is directed to a second vehicle with a battery apparatus mounted thereon. The battery apparatus includes a plurality of battery cells each having an internal resistance varying depending on a temperature. The vehicle includes: a plurality of temperature detection devices arranged for the plurality of battery cells; a voltage detection device for detecting a voltage of each of a plural cell blocks each composed of at least one battery cell; a current detection device for detecting a current flowing through each of the cell blocks; a detected internal resistance acquisition module for acquiring a detected internal resistance indicating an internal resistance of the cell block based on the detected voltage and the detected current; a reference internal resistance estimation module for estimating a reference internal resistance indicating an internal resistance of the battery cell based on a correlation to a temperature, based on the temperature detected by the plurality of temperature detection devices; and a failure determination module determining a failure of the battery cell based on the acquired detected internal resistance and the estimated reference internal resistance.

Since the battery apparatus mounted on the second vehicle as the power source can accurately determine a failure of the battery cell having an internal resistance varying depending on the temperature using a smaller number of temperature detection modules, the vehicle can achieve stable driving while more properly monitoring the battery apparatus as the power source.

The present invention is directed to a third battery apparatus including a plurality of battery cells each having an internal resistance varying depending on a temperature. The battery apparatus includes: a voltage detection device for detecting voltages of each of a plural cell blocks each composed of the same number of the battery cells; and a failure determination module for determining a failure of the battery cell by comparing the detected voltages between at least two cell blocks considered to be in an isothermal region.

The third battery apparatus determines a failure of the battery cell by comparing the detected voltage between at least two battery cells considered to be in an isothermal region. That is, between the battery cells contained in at least two battery cells considered to be in an isothermal region, the reference internal resistance indicating the internal resistance of the battery cell based on the correlation to the temperature can be considered to be basically substantially the same. In view of this point, the comparison of the voltages between at least two battery cells considered to be in an isothermal region allows an accurate determination of a failure of the battery cell, namely, the presence or absence of a failure of the cell in the cell block without using a temperature detection module.

In addition, in the third battery apparatus in accordance with the present invention, the failure determination module may determine a failure of the battery cell by comparing the detected voltages between at least two cell blocks for each of a plurality of areas grouped so as to contain at least two cell blocks considered to be in an individual isothermal region.

Further, the third battery apparatus in accordance with the present invention may further include: a battery representative temperature detection device for detecting a representative temperature of the battery apparatus; and a module for determining a failure of the temperature detection device by comparing between a temperature detected by the individual temperature detection device and a temperature detected by the battery representative temperature detection module.

In addition, the third battery apparatus in accordance with the present invention may further include: a temperature distribution estimation module for estimating a temperature distribution in the plurality of battery cells based on an operating state of the battery apparatus; and a module for determining a failure of the individual temperature detection module based on a temperature detected by the individual temperature detection module and the estimated temperature distribution.

Further, in the third battery apparatus in accordance with the present invention, the battery cell may be configured as a lithium secondary battery or a nickel-metal hydride battery.

The present invention is directed to a third vehicle with a battery apparatus mounted thereon. The battery apparatus includes a plurality of battery cells each having an internal resistance varying depending on a temperature. The vehicle includes: a voltage detection device for detecting voltages of each of a plural cell blocks each composed of the same number of the battery cells; and a failure determination module for determining a failure of the battery cell by comparing the detected voltages between at least two cell blocks considered to be in an isothermal region.

Since the battery apparatus mounted on the third vehicle as the power source can accurately determine a failure of the battery cell having an internal resistance varying depending on the temperature using a smaller number of temperature detection modules, the vehicle can achieve stable driving while more properly monitoring the battery apparatus as the power source.

The present invention is directed to a first failure determination method for a battery apparatus including a plurality of battery cells each having an internal resistance varying depending on a temperature, and a plurality of temperature detection devices arranged for the plurality of battery cells. The failure determination method includes the steps of: (a) acquiring a detected internal resistance indicating an internal resistance of a cell block composed of at least one battery cell based on a voltage of the cell block and a current flowing through the cell block; (b) acquiring a reference internal resistance indicating an internal resistance of the battery cell based on a correlation to a temperature in each of a plurality of areas grouped so as to contain at least one battery cell and one temperature detection device according to a predetermined constraint, based on the temperature detected by any one of the temperature detection device in the area; and (c) determining a failure of the battery cell based on the detected internal resistance acquired in step (a) and the reference internal resistance acquired in step (b).

According to the first method, a temperature detected by any one of the temperature detection modules in an individual area is treated as a representative temperature of the battery cell in the area; a comparison is made between the reference internal resistance acquired based on the representative temperature and the detected internal resistance based on the detected voltage and the detected current; and this eliminates the need to install a temperature detection module in every battery cell; and thus a smaller number of temperature detection modules can be used to accurately determine a failure of the battery cell having an internal resistance varying depending on the temperature. It should be noted that the sequence of executing steps (a) and (b) is not restrictive to this sequence, but may be in any sequence.

In addition, in the first failure determination method for a battery apparatus in accordance with the present invention, the predetermined constraint may be a constraint based on a temperature distribution in the plurality of battery cells for grouping the plurality of battery cells into areas so as to contain the battery cell in an isothermal region within one the area.

Further, in the first failure determination method for a battery apparatus in accordance with the present invention, the battery apparatus may further include a temperature distribution pattern storage for storing a plurality of temperature distribution patterns in the plurality of battery cells according to an operating environment of the battery apparatus as the predetermined constraint; and an environmental information acquisition module for acquiring environmental information related to the operating environment. And the step (b), based on a temperature distribution pattern corresponding to the acquired environmental information in the temperature distribution patterns stored in the temperature distribution pattern storage, may identify a plurality of the temperature detection devices used for failure determination of the battery cell and the cell blocks contained in the areas corresponding to the plurality of temperature detection devices used for failure determination of the battery cell; and acquire the reference internal resistance of the cell block of each of the areas.

The present invention is directed to a second failure determination method for a battery apparatus including a plurality of battery cells each having an internal resistance varying depending on a temperature, and a plurality of temperature detection devices arranged for the plurality of battery cells. The failure determination method includes the steps of: (a) acquiring a detected internal resistance indicating an internal resistance of a cell block composed of at least one battery cell based on a voltage of the cell block and a current flowing through the cell block; (b) acquiring a reference internal resistance indicating an internal resistance of the battery cell based on a correlation to a temperature, based on the temperatures detected by the plurality of temperature detection devices; and (c) determining a failure of the battery cell based on the detected internal resistance acquired in step (a) and the reference internal resistance acquired in step (b).

According to the second method, the reference internal resistance of the battery cell is estimated based on the temperatures detected by a plurality of temperature detection modules; a comparison is made between the estimated reference internal resistance and the detected internal resistance based on the detected voltage and the detected current; this comparison can eliminate the need to install a temperature detection module in every battery cell; and thus a smaller number of temperature detection modules can be used to accurately determine a failure of the battery cell having an internal resistance varying depending on the temperature. It should be noted that the sequence of executing steps (a) and (b) is not restrictive to this sequence, but may be in any sequence.

In addition, in the second failure determination method for a battery apparatus according to the present invention, the cell block may be composed of a serially connected plurality of the battery cells; the step (b) may estimate a temperature of each of the battery cells based on the temperature detected by the plurality of temperature detection modules, may acquire the reference internal resistance of each of the battery cells based on the estimated temperature, and may calculate the reference internal resistance of each of the cell blocks based on the acquired reference internal resistance of the battery cell. And the step (c) may determine the presence or absence of an abnormal cell in each of the cell blocks based on the detected internal resistance acquired in step (a) and the reference internal resistance of the cell block acquired in step (b).

The present invention is directed to a third failure determination method for a battery apparatus including a plurality of battery cells each having an internal resistance varying depending on a temperature. The failure determination method includes the steps of: (a) detecting voltages of each of a plural cell blocks each composed of the same number of the battery cells; and (b) determining a failure of the battery cell by comparing the voltages detected in step (a) between at least two cell blocks considered to be in an isothermal region.

According to the third method, between the battery cells contained in at least two cell blocks considered to be in an isothermal region, the reference internal resistance indicating the internal resistance of the battery cell based on the correlation to the temperature can be considered to be basically substantially the same. In view of this point, the comparison of the voltages between at least two cell blocks considered to be in an isothermal region allows an accurate determination of a failure of the battery cell, namely, the presence or absence of a failure of the cell in the cell block without using a temperature detection module.

In addition, in the third failure determination method for a battery apparatus according to the present invention, the step (b) may determine a failure of the battery cell by comparing the detected voltages between at least two cell blocks for each of a plurality of areas grouped so as to contain at least two cell blocks considered to be in an individual isothermal region.

### BRIEF DESCRIPTION OF THE DRAWINGS

FIG. 1 is a schematic configuration drawing of a hybrid vehicle 20 mounting a high-voltage battery unit 400 as a battery apparatus in accordance with a first embodiment of the present invention;

FIG. 2 is a schematic configuration drawing showing an example of the high-voltage battery unit 400;

FIG. 3 is a flowchart showing an example of a cell failure determination routine executed by a battery ECU 50 in accordance with the first embodiment of the present invention;

FIG. 4A is an explanatory drawing illustrating a temperature distribution pattern;

FIG. 4B is an explanatory drawing illustrating a temperature distribution pattern;

FIG. 4C is an explanatory drawing illustrating a temperature distribution pattern;

FIG. 5 is an explanatory drawing illustrating an example of a reference internal resistance derivation map;

FIG. 6 is a flowchart showing an example of the temperature sensor failure determination routine executed by the battery ECU 50 in accordance with the first embodiment of the present invention;

FIG. 7 is a flowchart showing another example of the temperature sensor failure determination routine executed by the battery ECU 50 in accordance with the first embodiment of the present invention;

FIG. 8 is a flowchart showing an example of a cell failure determination routine executed by the battery ECU 50 in accordance with a second embodiment of the present invention;

FIG. 9 is a flowchart showing an example of a cell failure determination routine executed by the battery ECU 50 in accordance with a third embodiment of the present invention; and

FIG. 10 is an explanatory drawing illustrating a distribution pattern of a cell temperature Tcel(z) for each battery cell 450.

### BEST MODE FOR CARRYING OUT THE INVENTION

Hereinafter, the best mode for carrying out the invention will be described with reference to embodiments.

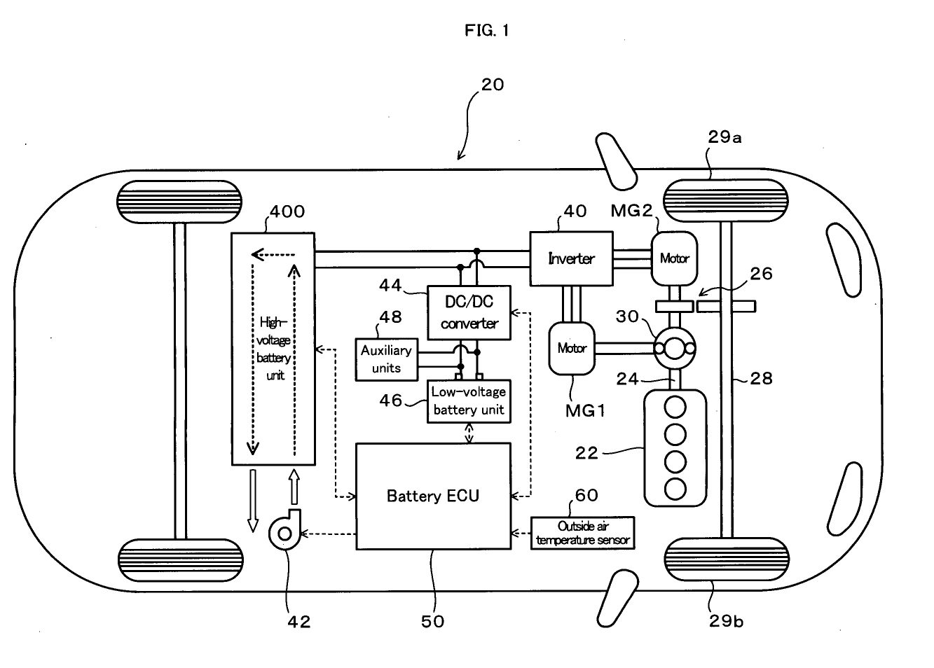

FIG. 1 is a schematic configuration drawing of a hybrid vehicle 20 mounting a high-voltage battery unit 400 as a battery apparatus in accordance with a first embodiment of the present invention. The hybrid vehicle 20 shown in the figure includes an engine 22 controlled by an engine electronic control unit (not shown) as a power output apparatus; a power distribution and integration mechanism 30 which is connected to a crankshaft 24 serving as an output shaft of the engine 22 through a damper (not shown) and is also connected to an axle 28 through a gear train 26; a motor MG1 connected to the power distribution and integration mechanism 30; a motor MG2 capable of inputting and outputting mechanical power to and from the axle 28; and a hybrid electronic control unit (not shown) for controlling the entire power output apparatus. The power distribution and integration mechanism 30 includes a planetary gear. A rotating shaft of the motor MG1 is connected to a carrier of the planetary gear, and the gear train 26 is connected to a ring gear of the planetary gear. In addition, the rotating shaft of the motor MG2 is connected to the ring gear through a deceleration mechanism (not shown) and the like. Finally, the mechanical power outputted to the ring gear by the engine 22 and the motors MG1 and MG2 is outputted to drive wheels 29a and 29b through the gear train 26 and the like.

The motor MG1 and the motor MG2 are configured as a well-known synchronous motor generator capable of operating as both an electric generator and an electric motor so as to transfer electric power to and from the high-voltage battery unit 400 through an inverter 40 controlled by a motor electronic control unit (not shown). A cooling fan 42 for cooling the high-voltage battery unit 400 is mounted in the high-voltage battery unit 400. The cooling fan 42 is driven by a motor or the like to draw air in through an air-intake (not shown) formed inside or outside the vehicle and feed the air to the high-voltage battery unit 400 so as to cool the high-voltage battery unit 400. The air which has been thermally exchanged with components of the high-voltage battery unit 400 is discharged outside the vehicle through a vent (not shown). A low-voltage battery unit 46 is connected to the high-voltage battery unit 400 through a DC/DC converter 44, and electric power is supplied from the low-voltage battery unit 46 to the cooling fan 42 and other auxiliary units 48. A battery electronic control unit (hereinafter referred to as “battery ECU”) 50 manages and controls the high-voltage battery unit 400, the cooling fan 42, and the low-voltage battery unit 46.

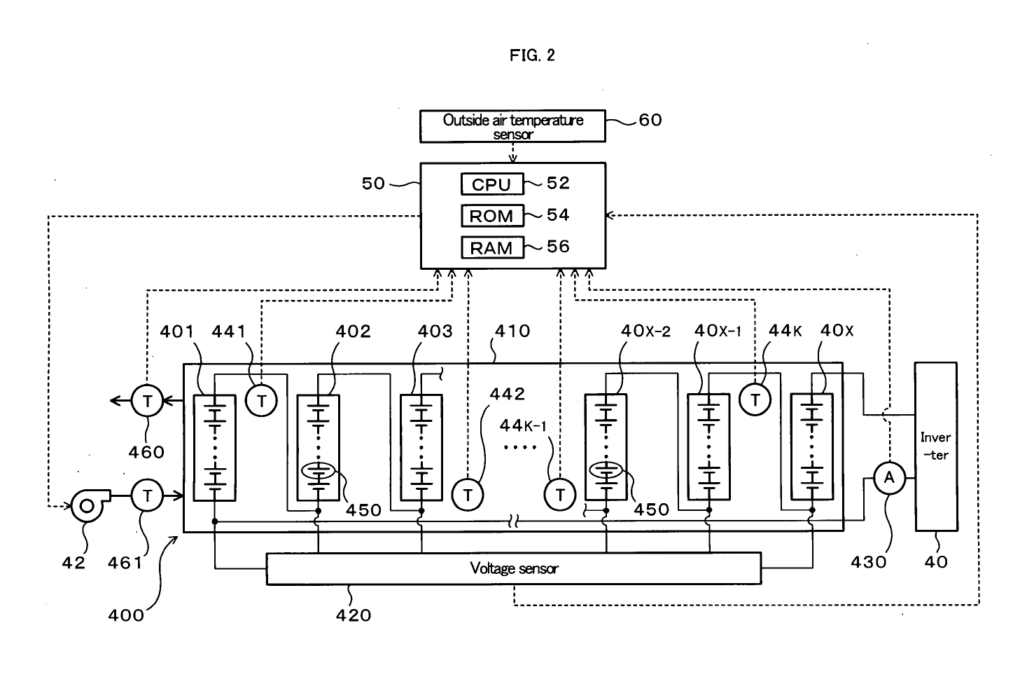

As shown in FIG. 2, the high-voltage battery unit 400 mounted in the above described hybrid vehicle 20 includes X number (e.g., 10 to 400) of battery modules 401, 402, . . . , 40x, . . . , 40X; which are arranged in a battery pack 410 so as to be serially connected thereto; a voltage sensor 420 capable of detecting voltages V(1), V(2), . . . , V(x), . . . , V(X) for each battery module 40x; a current sensor 430 for detecting current value I when the high-voltage battery unit 400 charges and discharges; and a plurality (K) of temperature sensors 441, 442, . . . , 44k, . . . , 44K. Each of the battery modules 401 to 40X includes Y number (e.g., 2 to 10) of serially connected battery cells 450 serving as a unit battery; an equalization circuit (not shown) for equalizing the voltage of each battery cell 450, and the like. It should be noted that the number of battery cells 450 contained in an individual battery module 40x is not restrictive to be the same, but may be different among the battery modules 40x. According to the present embodiment, the individual battery cell 450 is configured as, for example, a lithium secondary battery which has a relatively small internal resistance and the internal resistance depends relatively highly on the temperature. As understood from FIG. 2, the temperature sensors 441 to 44X are arranged in an appropriate place in the battery pack, such that one sensor 44k corresponds to a plurality of battery modules 40x; and detect the ambient temperatures T(1), T(2), . . . , T(k), . . . , T(K) around the arranged place. The battery pack 410 has an air intake port for introducing air from the above described cooling fan 42; and an air discharge port for discharging air thermally exchanged with individual battery modules 410 to 40X and the like. A temperature sensor (coolant temperature sensor) 461 is arranged in the vicinity of the air intake port so as to detect the temperature of air (cooling medium) from the cooling fan 42; and a coolant temperature sensor 460 is arranged in the vicinity of the air discharge port so as to detect the temperature (hereinafter referred to as “coolant temperature”) Tc of air thermally exchanged with individual battery modules 410 to 40X, namely, air used to cool the high-voltage battery unit 400.

As shown in FIG. 2, the battery ECU 50 for managing such a high-voltage battery unit 400 is configured as a microcomputer around a CPU 52 and in addition to the CPU 52, includes a ROM 54 for storing a processing program and the like; a RAM 56 for temporarily storing various kinds of data and the like; a timer (not shown) for clocking the time according to a clocking command; an input/output port (not shown); a communication port (not shown) and the like. The battery ECU 50 receives the voltages V(1) to V(X) from the above described voltage sensor 420; a current value I from the current sensor 430; the temperatures T(1) to T(K) from the temperature sensors 441 to 44K; a coolant temperature Tc from the coolant temperature sensor 460; an outside air temperature To from the outside air temperature sensor 60 and the like are inputted through an input port. The battery ECU 50 manages the high-voltage battery unit 400 based on the above described data. For example, as a part of management of the high-voltage battery unit 400, the battery ECU 50 calculates the SOC (state of charge) based on an integrated value of the current values detected by the current sensor 430 and outputs data about the state of the high-voltage battery unit 400 and the like to other electronic control units including the hybrid electronic control unit as needed through communication. In addition, a drive signal is outputted from the battery ECU 50 to the cooling fan 42 through an output port.

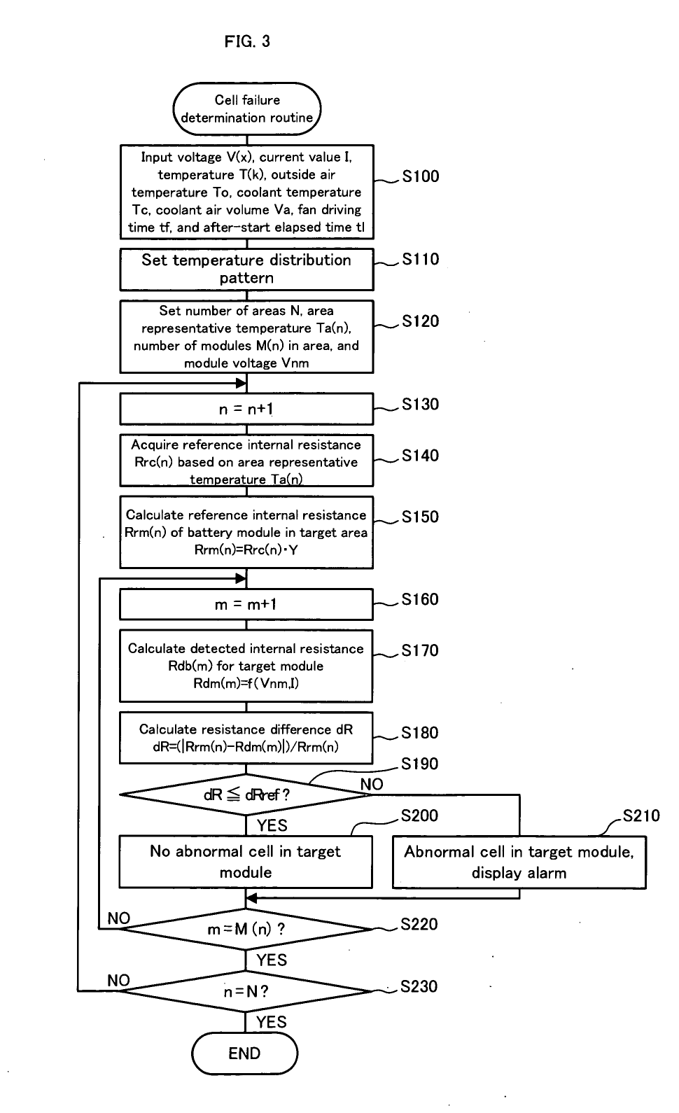

Next, a procedure for determining a failure of the battery cell 450 in the high-voltage battery unit 400 in accordance with the first embodiment configured as described above will be described. FIG. 3 is a flowchart showing an example of a cell failure determination routine executed by a battery ECU 50 in accordance with the first embodiment of the present invention. For example, this routine is executed at a predetermined timing while the high-voltage battery unit 400 is discharging.

When the cell failure determination routine starts as shown in FIG. 3, the CPU 52 of the battery ECU 50 executes a process of inputting data required for failure determination such as the voltage V(x) from the voltage sensor 420; the current value I from the current sensor 430; the temperature T(k) from the individual temperature sensors 441 to 44K; the outside air temperature To from the outside air temperature sensor 60; the coolant temperature Tc from the coolant temperature sensor 460; the coolant air volume Va, namely, the volume of air fed into the battery pack 410 by the cooling fan 42; the fan driving time tf indicating the time period of driving the cooling fan 42; and the after-start elapsed time t1 indicating the time elapsed since the high-voltage battery unit 400 started discharging (step S100). It should be noted that a value is assumed to be inputted, which the coolant air volume Va is calculated separately by the battery ECU 50 based on a command value and the like with respect to the motor of the cooling fan 42 and is stored in a predetermined memory area. Further, the fan driving time tf is assumed to be an input value of the timer which starts clocking the time when the cooling fan 42 starts; and the after-start elapsed time t1 is assumed to be an input value of the timer which starts clocking the time when the charging or discharging starts.

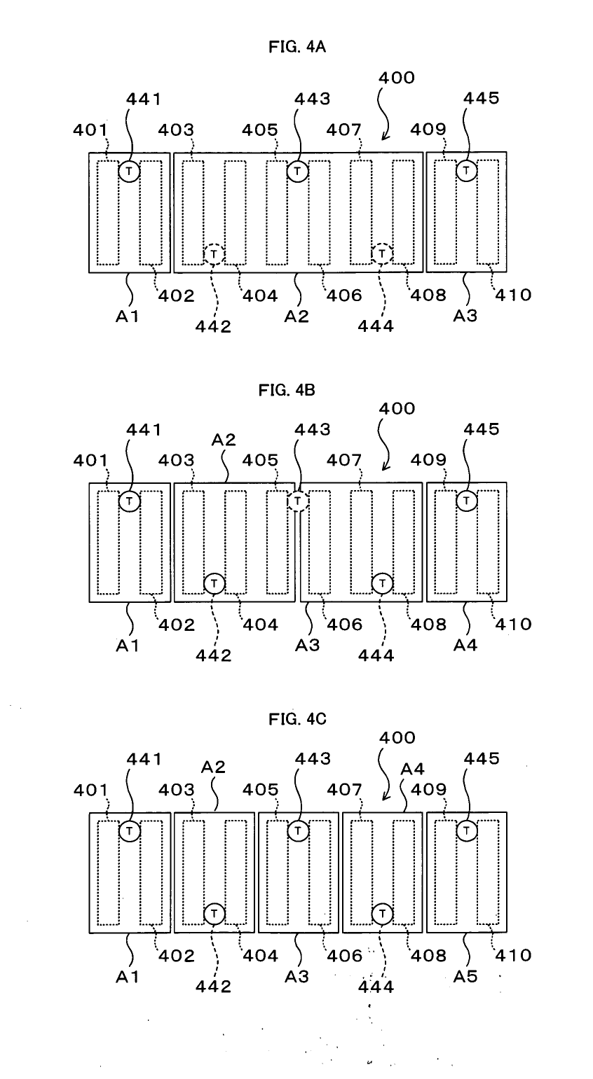

Following the data input process in step S100, the temperature distribution pattern of a plurality of battery cells 450 in the battery pack 410 is set based on the information about the operating environment of the high-voltage battery unit 400, that is, the outside air temperature To, the coolant temperature Tc, the coolant air volume Va, the fan driving time tf, and the after-start elapsed time t1 (step S110). Here, in the high-voltage battery unit 400, a temperature distribution occurs in the plurality of battery cells 450; and the temperature distribution changes according to the operating environment of the high-voltage battery unit 400 which is determined by such a parameter as the outside air temperature To, the coolant temperature Tc, the coolant air volume Va, the fan driving time tf, and the after-start elapsed time t1. With that in mind, according to the present embodiment, a plurality of temperature distribution patterns depending on the operating environment of the high-voltage battery unit 400 are stored in the ROM 54. In step S110, the temperature distribution patterns according to the operating environment of the high-voltage battery unit 400 which is determined by the outside air temperature To, the coolant temperature Tc, the coolant air volume Va, the fan driving time tf, and the after-start elapsed time t1 are derived and set from the ROM 54. FIGS. 4A, 4B, and 4C illustrate the temperature distribution patterns. As illustrated in FIGS. 4A to 4C, the individual temperature distribution pattern is a constraint for dividing a plurality of battery cells 450 (battery module 40x) into a plurality of areas A1, . . . , An, . . . , AN (hereinafter “n” refers to the area number) so as to include a battery cell 450 (in units of battery modules 40x according to the present embodiment) in an isothermal region within the area An, and is prepared in advance through an experiment and an analysis for each representative operating environment of the high-voltage battery unit 400. Each temperature distribution pattern specifies the number of areas N; the battery module 40x serving as a cell block contained in an individual area An; the temperature sensor 44k representing the area An; and the number of battery modules M(n) contained in an individual area An. When such a plurality of temperature distribution patterns are used, the range of an individual area An is also changed as a temperature distribution pattern is changed. For this reason, the present embodiment specifies the number (K) of a plurality of temperature sensors 44k and its arrangement position such that the number (K) is a minimum value, and the individual area An contains at least one temperature sensor 44k regardless the change of a temperature distribution pattern. It should be noted that, here, “isothermal region” is specified according to the degree of temperature dependence of the internal resistance of the battery cell 450, and thus, it is not essential that the internal resistances of the individual battery cells 450 must be within a strict temperature range as long as the internal resistances thereof in one area An are approximately equal. Further, the number of battery modules 40x and the number of temperature sensors 44k in FIGS. 4A to 4C are just for illustrative purposes for ease of explanation.

After the temperature distribution patterns according to the operating environment of the high-voltage battery unit 400 were set, the number of areas N, the area representative temperature Ta(n) used for failure determination, the number of modules M(n) in an area indicating the number of battery modules 40x contained in the individual area An and the module voltage Vnm are set based on the set temperature distribution pattern (step S120). For example, if the temperature distribution pattern shown in FIG. 4A is set in step S110, the number of areas N=3; the temperature T(1) detected by the temperature sensor 441 is set as the area representative temperature Ta(1) of the area A1; the temperature T(3) detected by the temperature sensor 443 is set as the area representative temperature Ta(2) of the area A2; the temperature T(5) detected by the temperature sensor 445 is set as the area representative temperature Ta(3) of the area A3; as the number of cell blocks M(n) in an area, for the area A1, M(1)=2; for the area A2, M(2)=6; and for the area A3, M(3)=2. The module voltage Vnm indicates the voltage of the mth battery module 40x in an area An. For example, if the temperature distribution pattern shown in FIG. 4A is set in step S110, the module voltage is set as V11=V(1), V12=V(2), V21=V(3), V22=V(4), V23=V(5) V24=V(6), V25=V(7), V26=V(8), V31=V(9), and V32=V(10). It should be noted that as the area A2 in the temperature distribution pattern shown in FIG. 4A, if the area An contains two or more temperature sensors 44k, the temperature T(k) detected by any one of the temperature sensors T(k) may be selected as the area representative temperature Ta(n) of the area An, but according to the present embodiment, the temperature sensors T(k) deemed most appropriate for such an area An is specified by the temperature distribution pattern.

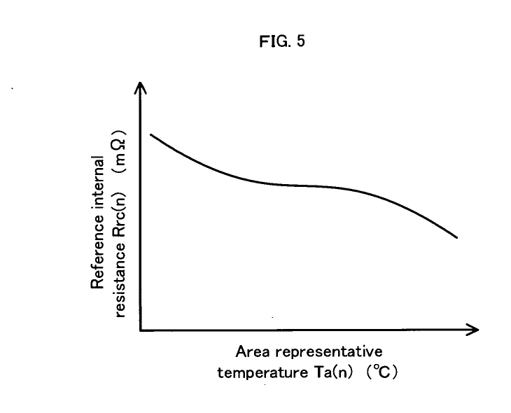

Subsequently, the variable n (default value=0) indicating an area number is incremented by 1 (step S130). Then, with respect to the area An (area A1 at first) corresponding to the variable n, a reference internal resistance Rrc(n) indicating the internal resistance of the battery cell 450 based on the correlation to the cell temperature, is acquired based on the area representative temperature Ta(n) set in step S120 (step S140). According to the present embodiment, the relation between the area representative temperature Ta(n) and the reference internal resistance Rrc(n) of the battery cell 450 is specified in advance and is stored in the ROM 54 as a reference internal resistance derivation map. As the reference internal resistance Rrc(n), the internal resistance corresponding to a given area representative temperature Ta(n) is derived from the map. FIG. 5 illustrates an example of the reference internal resistance derivation map. When the reference internal resistance Rrc(n) of the battery cell 450 in the area An is acquired, the acquired reference internal resistance Rrc(n) is multiplied by the number (Y) of battery cells 450 contained in the individual battery module 40x to obtain the reference internal resistance Rrm(n) of the battery module 40x contained in the area An (step S150). Subsequently, the variable m (default value=0) indicating the battery module number in the individual area An is incremented by 1 (step S160). For the mth battery module 40x in the individual area An, the detected internal resistance Rdm(m) indicating the internal resistance of the battery module 40x based on the module voltage Vnm indicating the detected voltage, and the detected current value I is calculated by the following expression (1) (step S170). It should be noted that “E” in the expression (1) indicates a rated voltage of the individual battery module 40x. Further, the resistance difference dR indicating a degree of difference between the reference internal resistance Rrm(n) of the individual battery module 40x in the area An calculated in step S150 and the detected internal resistance Rdm(m) bf the mth battery module 40x in the area An set in step S170 is calculated by the following expression (2) (step S180). Subsequently, a determination is made to see whether the resistance difference dR is equal to or less than the threshold dRref (step S190). If the resistance difference dR is equal to or less than the threshold dRref, a determination is made that the mth battery module 40x in the area An does not have an abnormal cell (step S200) and if the resistance difference dR is greater than the threshold dRref, a determination is made that the mth battery module 40x in the area An has an abnormal cell and an alarm indicating that the battery module 40x has an abnormal cell is displayed on an instrument panel (not shown) (step S210). Following the step S200 or S210, a determination is made to see whether the variable m matches the number of modules M(n) in the area An (step S220). If the variable m does not match the number of modules M(n), the above described processes in steps S160 to S200 or to S210 are repeated until the variable m matches the number of modules M(n) If the variable m matches the number of modules M(n), a determination is made to see whether the variable n matches the number of areas N (step S230). If the variable n does not match the number of areas N, the above described processes in steps S130 to S220 are repeated until the variable n matches the number of areas N. Thereby, the presence or absence of an abnormal cell can be determined in all the battery modules 40x. When the variable n matches the number of areas N, the routine is terminated.

Rdm(m)=(E−Vnm)/I (1)

dr=(|Rrm(n)−Rdm(m)|)/Rrm(n) (2)

As described above, according to the high-voltage battery unit 400 serving as the battery apparatus in accordance with the first embodiment, for each of the plurality of areas A1 to AN grouped by the temperature distribution pattern set in step S110, the reference internal resistance Rrc(n) indicating the internal resistance of the battery cell 450 based on the correlation to the temperature is acquired based on the area representative temperature Ta(n) detected by any one of the temperature sensors 44k in the individual area An (step S140); for each battery module 40x serving as a cell block composed of Y number of battery cells 450, the detected internal resistance Rdm(m) indicating the internal resistance of the battery module 40x based on the detected voltage V(x) and the detected current value I is acquired; on the basis of the reference internal resistance Rrm(n) of the battery module 40x calculated by the acquired reference internal resistance Rrc(n) and the detected internal resistance Rdm(m), a determination is made to see whether the battery cell 450 has an abnormality, namely, whether an individual battery module 40x has an abnormal cell or not (steps S180 to S210) Like this, the temperature T(k) detected by any one of the temperature sensors 44k in the individual area An is specified as the area representative temperature Ta(n) indicating the representative temperature of the battery cells 450 in the area An; and a comparison is made between the reference internal resistance Rrc(n) acquired based on the area representative temperature Ta(n) and the detected internal resistance Rdm(m) based on the detected voltage V(x) and the detected current value I; this eliminates the need to install a temperature sensor in every battery cell 450; and thus a smaller number of temperature sensors 44k can be used to accurately determine a failure of the battery cell 450 having an internal resistance varying depending on the temperature.

In addition, according to the present embodiment, a temperature distribution pattern is used to group a plurality of battery cells 450 into areas so as to include a battery module 40x (battery cell 450) in an isothermal region within an area An; then, a reference internal resistance of an individual battery cell 450 within an area An can be considered as substantially the same; and thereby, the reference internal resistance Rrc(n) acquired based on the temperature T(k) detected by any one of the temperature sensors 44k in an individual area An, namely, the area representative temperature Ta(n) can be more proper and the failure determination accuracy of the battery cell 450 can be improved. Further, the temperature distribution of a plurality of battery cells 450 changes according to the operating environment of the high-voltage battery unit 400. Therefore, if a plurality of temperature distribution patterns are stored according to the operating environment of the high-voltage battery unit 400 and a plurality of battery modules 40x (battery cell 450) are grouped into areas based on a temperature distribution pattern according to the outside air temperature To and other information about the operating environment, the reference internal resistance Rrc(n) acquired based on the area representative temperature Ta(n) detected by any one of the temperature sensors 44k in an individual area An, can be constantly more proper and a failure of the battery cell 450 can be determined more accurately.

It should be noted that according to the above first embodiment, the area grouping is based on the temperature distribution in units of battery modules 40x, but the present invention is not restrictive to this. For example, the area grouping may be based on the temperature distribution in units of cell blocks composed of a smaller number of battery cells 450 than that of the battery cells 450 contained in a battery module 40x. In this case, the number of battery cells may be different for each cell block. Further, in particular, if the number of battery cells 450 is small, the voltage is detected for each battery cell 450 and a comparison may be made between the reference internal resistance and the detected internal resistance for each battery cell 450 so as to directly identify an abnormal cell. Still further, according to the above first embodiment, the temperature (exhaust side temperature) of air used to cool the high-voltage battery unit 400 detected by the coolant temperature sensor 460 is used as the coolant temperature Tc, but the present invention is not restrictive to this. For example, when the temperature distribution pattern is set (estimated) to a plurality of battery cells 450 in the battery pack 410, the temperature (suction side temperature) of air from the cooling fan 42 detected by the temperature sensor 461 may be used, or both the temperatures detected by the coolant temperature sensor 460 and the temperature sensor 461 may be used.

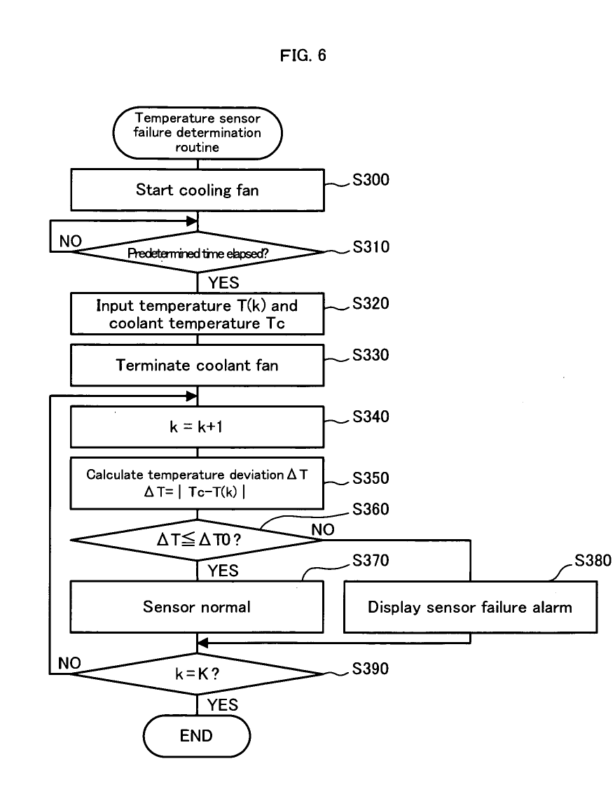

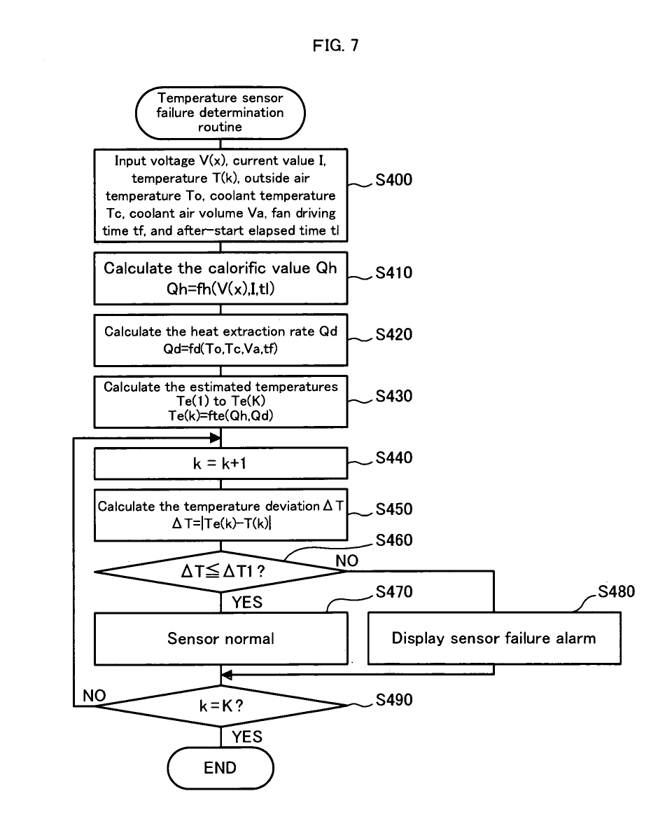

Then, with reference to FIGS. 6 and 7, the procedure for determining a failure of the temperature sensors 441 to 44K in the high-voltage battery unit 400 in accordance with the first embodiment of the present invention will be described.

FIG. 6 is a flowchart showing an example of the temperature sensor failure determination routine executed by the battery ECU 50 in accordance with the present embodiment. For example, the routine is executed at a predetermined timing such as immediately after the hybrid vehicle 20 started when the temperature distribution according to the operating environment is relatively difficult to occur in the high-voltage battery unit 400.

When the temperature sensor failure determination routine of FIG. 6 starts, first, the CPU 52 of the battery ECU 50 starts the cooling fan 42 (step S300). Then, a determination is made to see whether a predetermined time has elapsed since the cooling fan 42 started (step S310). When a determination is made that the predetermined time has elapsed enough to consider the temperature of air serving as a coolant discharged from the discharge port of the battery pack 410 as the representative temperature of the high-voltage battery unit 400 since the cooling fan 42 started, the process is executed of inputting data required for failure determination such as the temperature T(k) from the individual temperature sensors 441 to 44K, and the coolant temperature Tc from the coolant temperature sensor 460 (step S320). Then, the cooling fan 42 is terminated (step S330), and the variable k (default value=0) indicating the number of an individual temperature sensor 441 to 44K is incremented by 1 (step S340). For the kth temperature sensor 44k, the temperature T(k) detected by the temperature sensor 44k is subtracted from the coolant temperature Tc inputted in step S320 to calculate the temperature deviation ΔT indicating an absolute value of the deviation (step S350). Then, a determination is made to see whether the temperature deviation ΔT is equal to or less than a predetermined threshold ΔT0 (step S360). If the temperature deviation ΔT is equal to or less than the threshold ΔT0, the kth temperature sensor 44k is determined to be normal (step S370). On the contrary, if the temperature deviation ΔT is greater than the threshold ΔT0, a failure is determined to occur in the kth temperature sensor 44k and an alarm indicating a failure in the temperature sensor 44k is displayed on an instrument panel (not shown) (step S380). Following the step S370 or the step S380, a determination is made to see whether the variable k matches the number (K) of temperature sensors 44k (step S390). If the variable k does not match the value K, the above processes in steps S340 to S370 or to S380 are repeated until the variable k matches the value K. When the variable k matches the value K, the routine is terminated. As described above, a failure in the individual temperature sensors 441 to 44K can be accurately determined by a comparison between the coolant temperature Tc detected by the coolant temperature sensor 460 which can be considered to be a representative temperature of the high-voltage battery unit 400 and the temperature T(k) detected by the individual temperature sensors 441 to 44K, thereby improving the reliability of the values detected by the temperature sensors 441 to 44K as well as the reliability of the failure determination of the battery cell 450.

FIG. 7 is a flowchart showing another example of the temperature sensor failure determination routine executed by the battery ECU 50 in accordance with the first embodiment of the present invention. For example, the routine is executed at a predetermined timing while the high-voltage battery unit 400 is discharging.

When the temperature sensor failure determination routine starts as shown in FIG. 7, first, the CPU 52 of the battery ECU 50 executes a process of inputting data required for failure determination such as the voltage V(x) from the voltage sensor 420; the current value I from the current sensor 430; the temperature T(k) from the individual temperature sensors 441 to 44K; the outside air temperature To from the outside air temperature sensor 60; the coolant temperature Tc from the coolant temperature sensor 460; the coolant air volume Va; the fan driving time tf; and the after-start elapsed time t1 (step S400). Following the data input process in step S400, a calorific value Qh of the entire high-voltage battery unit 400 is calculated based on the voltage V(x), the current value I, and the after-start elapsed time t1, and the like inputted in step S400 (step S410). According to the present embodiment, the relations between the calorific value Qh of the entire high-voltage battery unit 400 and the voltage V(x), the current value I, and the after-start elapsed time t1, and the like are determined in advance and stored in the ROM 54 as a calorific value derivation map (not shown). As the calorific value Qh, the values corresponding to a given voltage V(x), a current value I, and an after-start elapsed time t1, and the like are derived from the map. Then, the heat extraction rate Qd from the high-voltage battery unit 400 due to cooling, radiation cooling, and convection cooling by the cooling fan 42 is calculated based on the outside air temperature To, the coolant temperature Tc, the coolant air volume Va, the fan driving time tf, and the like inputted in step S400 (step S420). According to the present embodiment, the relations between the heat extraction rate Qd and the outside air temperature To, the coolant temperature Tc, the coolant air volume Va, the fan driving time tf, and the like are determined in advance and stored in the ROM 54 as a heat extraction rate derivation map (not shown). As the heat extraction rate Qd, a value corresponding to a given outside air temperature To, a coolant temperature Tc, a coolant air volume Va, a fan driving time tf, and the like is derive(d from the map. Further, the estimated temperatures Te(1) to Te(K) indicating estimated temperatures in the vicinity of the individual temperature sensors 441 to 44K are calculated based on the calorific value Qh calculated in step S410, the heat extraction rate Qd calculated in step S420 and the like (step S430). According to the present embodiment, the relations between the temperatures in the vicinity of the individual temperature sensors 441 to 44K and the calorific value Qh and the heat extraction rate Qd and the like are determined in advance and stored in the ROM 54 as a temperature estimation map (not shown), and the estimated temperatures Te(1) to Te(K) are calculated using the calorific value Qh, the heat extraction rate Qd and the like and the temperature estimation map.

Subsequently, the variable k (default value=0) indicating the number of an individual temperature sensors 441 to 44K is incremented by 1 (step S440). For the kth temperature sensor 44k, the temperature T(k) detected by the temperature sensor 44k is subtracted from the estimated temperature Te(k) calculated and inputted in step S430 to calculate the temperature deviation AT indicating an absolute value of the deviation (step S450). Then, a determination is made to see whether the temperature deviation ΔT is equal to or less than a predetermined threshold ΔT1 (step S460). If the temperature deviation ΔT is equal to or less than the threshold ΔT1, the kth temperature sensor 44k is determined to be normal (step S470). On the contrary, if the temperature deviation ΔT is greater than the threshold ΔT1, a failure is determined to occur in the kth temperature sensor 44k and an alarm indicating a failure in the temperature sensor 44k is displayed on an instrument panel (not shown) (step S480). Following the step S470 or the step S480, a determination is made to see whether the variable k matches the number (K) of temperature sensors 44k (step S490). If the variable k does not match the value K, the above processes in steps S440 to S470 or to S480 are repeated until the variable k matches the value K. When the variable k matches the value K, the routine is terminated. In this way, the estimated temperatures Te(1) to Te(K) indicating estimated temperatures in the vicinity of temperature sensors 441 to 44K are calculated as the temperature distribution in the plurality of battery cells 450 based on the operating state of the high-voltage battery unit 400. Thereby, a failure in the individual temperature sensors 441 to 44K can be accurately determined by a comparison between the temperatures T(1) to T(K) actually measured by the individual temperature sensors 441 to 44K and the estimated temperatures Te(1) to Te(K). Therefore, when the temperature sensor failure determination routine shown in FIG. 7 is executed, the reliability of the values detected by the temperature sensors 441 to 44K as well as the reliability of the failure determination of the battery cell 450 can be improved.

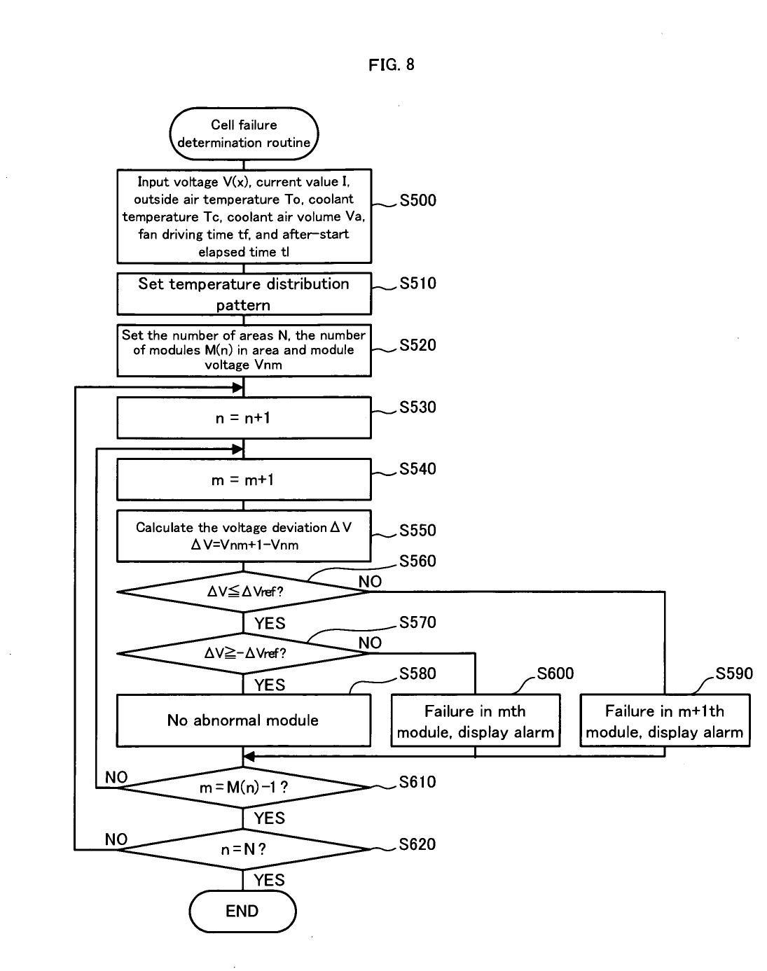

Next, the battery apparatus in accordance with the second embodiment of the present invention will be described. A high-voltage battery unit 400B serving as the high-voltage battery unit in accordance with the second embodiment of the present invention has substantially the same hardware configuration as the high-voltage battery unit 400 in accordance with the first embodiment of the present invention. Therefore, hereinafter, in order to avoid duplicate explanation, the same reference numerals or characters as those of the high-voltage battery unit 400 in accordance with the first embodiment are used for the high-voltage battery unit 400B in accordance with the second embodiment and the detailed explanation is omitted. According to the second embodiment, the battery ECU 50 for controlling the high-voltage battery unit 400B executes the cell failure determination routine shown in FIG. 8 instead of the cell failure determination routine shown in FIG. 3. For example, the cell failure determination routine is also executed at a predetermined timing while the high-voltage battery unit 400B is discharging.

When the cell failure determination routine starts as shown in FIG. 8, the CPU 52 of the battery ECU 50 executes a process of inputting data required for failure determination such as the voltage V(x) from the voltage sensor 420; the current value I from the current sensor 430; the outside air temperature To from the outside air temperature sensor 60; the coolant temperature Tc from the coolant temperature sensor 460; the coolant air volume Va; the fan driving time tf; and the after-start elapsed time t1 (step S500). Following the data input process in step S500, in the same way as in step S110 for the cell failure determination routine of FIG. 3, the temperature distribution pattern of a plurality of battery cells 450 in the battery pack 410 is set based on the information about the operating environment of the high-voltage battery unit 400 such as the outside air temperature To; the coolant temperature Tc; the coolant air volume Va; the fan driving time tf, and the after-start elapsed time t1, (step S510). After the temperature distribution patterns according to the operating environment of the high-voltage battery unit 400 was set, in the same way as in step S120 for the cell failure determination routine of FIG. 3, the number of areas N, the number of cell blocks M(n) in an area indicating the number of cell blocks contained in the individual area An and the module voltage Vnm are set based on the set temperature distribution pattern (step S520).

Subsequently, the variable n (default value=0) indicating the area number is incremented by 1 (step S530), and the variable m (default value=0) indicating the battery module number in the individual area An is incremented by 1 (step S540). Then, the module voltage Vnm of the mth battery module 40x is subtracted from the module voltage Vnm+1 of the m+1th battery module 40x+1 in the area An to calculate the voltage deviation ΔV (step S550). Subsequently, a determination is made to see whether the voltage deviation ΔV is equal to or less than a predetermined threshold ΔVref (positive value) (step S560). If the voltage deviation ΔV is equal to or less than the threshold ΔVref, further a determination is made to see whether the voltage deviation ΔV is equal to or greater than the threshold −ΔVref (step S570). If an affirmative judgment is made in step S570, namely, if the voltage deviation ΔV is equal to or greater than the threshold −ΔVref, and the voltage deviation ΔV is equal to or less than the threshold ΔVref, a determination is made that no abnormal cell is contained in the m+1th and mth battery module 40x+1 and 40x (step S580). On the contrary, in step S 560, if a determination is made that the voltage deviation ΔV is greater than the threshold ΔVref, a determination is made that an abnormal cell is contained in the m+1th battery module 40x+1, and an alarm indicating that an abnormal cell is contained in the battery module 40x+1 is displayed on an instrument panel (not shown) (step S590). Alternatively, if a determination is made in step S570 that the voltage deviation ΔV is less than the threshold ΔVref, a determination is made that an abnormal cell is contained in the mth battery module 40x, and an alarm indicating that an abnormal cell is contained in the battery module 40x is displayed on an instrument panel (not shown) (step S600). Following the process in steps S580 to S600, a determination is made to see whether the variable m matches a value obtained by decrementing the number of modules M(n) in the area An by 1 (step S610). If a negative judgment is made, the above described processes in steps S540 to S580 or to S590 or to S600 are repeated until the variable m matches the number of modules M(n)−1. On the contrary, if the variable m matches the number of modules M(n)−1, a determination is made to see whether the variable n matches the number of areas N (step S620). If the variable n does not match the number of areas N, the above described processes in steps S530 to S610 are repeated until the variable n matches the number of areas N. Thereby, the presence or absence of an abnormal cell can be determined in all the battery modules 40x. When the variable n matches the number of areas N, the routine is terminated.

As described above, according to the high-voltage battery unit 400B serving as the battery apparatus in accordance with the second embodiment of the present invention, a comparison of the detected voltages V(x) is made between the at least two battery modules 40x for each of the plurality of areas An grouped so as to contain a battery module 40x as at least two cell blocks considered to be in an individual isothermal region to determine a failure in the battery cell 450 (steps S540 to S610). In other words, in the individual area An containing at least two battery modules 40x considered to be in an isothermal region, the reference internal resistance indicating the internal resistance of the battery cell 450 based on the correlation to the temperature can be considered to be substantially the same. In view of this point, the comparison of the detected voltages V(x) between at least two battery modules 40x in an individual area An allows an accurate determination of a failure of the battery cell 450, namely, the presence or absence of an abnormal cell in the battery module 40x.

It should be noted that according to the above second embodiment, a comparison of the detected voltages V(x) is made between the mutually adjacent battery modules 40x in an area An to determine a failure of the battery cell 450, but the present invention is not restrictive to this. For example, a comparison of the detected voltages (Vx) is made between all the battery modules 40x in an area An to extract a battery module 40x containing an abnormal cell. Alternatively, a calculation is made to obtain an average value of the detected voltages V(x) of all the battery modules 40x in an area An, and a comparison may be made between the obtained average value and the detected voltage V(x) of a battery module 40x in the area An to determine a failure of the battery cell 450. Further, the present embodiment does not always need to make a comparison of voltages between the battery modules 40x for each of the plurality of areas An grouped based on the temperature distribution pattern. For example, at least two battery modules 40x considered to be in an isothermal region are extracted, and a comparison of the detected voltages may be made between the at least two battery modules 40x to determine a failure of the battery cell 450. Alternatively, according to the present embodiment, a comparison of voltages may be made in units of cell blocks composed of a smaller number of battery cells 450 than that of the battery cells 450 contained in a battery module 40x. Further, it is obvious that the temperature sensor failure determination routine explained related to the first embodiment can be applied to the high-voltage battery unit 400B of the second embodiment.

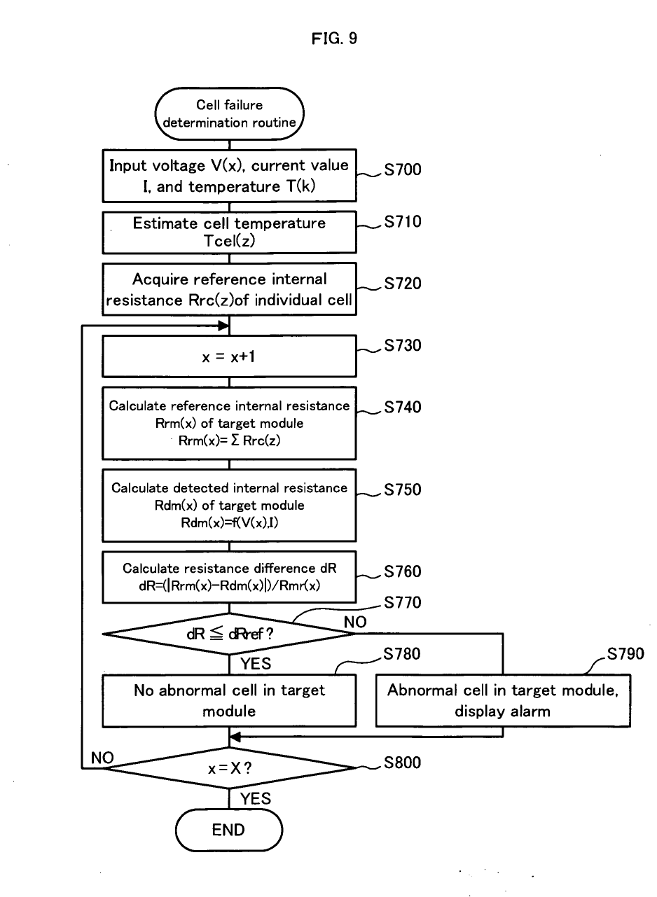

Next, the battery apparatus in accordance with the third embodiment of the present invention will be described. A high-voltage battery unit 400C serving as the battery apparatus in accordance with the third embodiment of the present invention also has substantially the same hardware configuration as the high-voltage battery unit 400 in accordance with the first embodiment of the present invention. Therefore, hereinafter, in order to avoid duplicate explanation, the same reference numerals or characters as those of the high-voltage battery unit 400 in accordance with the first embodiment are used for the high-voltage battery unit 400C in accordance with the third embodiment and the detailed explanation is omitted. According to the third embodiment, the battery ECU 50 for controlling the high-voltage battery unit 400C executes the cell failure determination routine shown in FIG. 9 instead of the cell failure determination routine shown in FIGS. 3 and 8. For example, the cell failure determination routine is also executed at a predetermined timing while the high-voltage battery unit 400C is discharging.

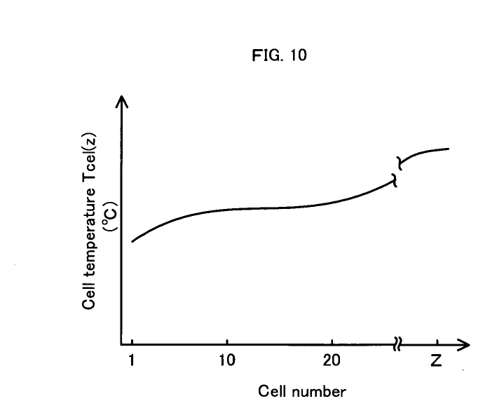

When the cell failure determination routine starts as shown in FIG. 9, the CPU 52 of the battery ECU 50 executes a process of inputting data required for failure determination such as the voltage V(x) from the voltage sensor 420; the current value I from the current sensor 430; and temperature T(k) from the individual temperature sensors 441 to 44K (step S700). Following the data input process in step S700, the cell temperature Tcel(z) (note that z=1 to Z) indicating the temperatures of all (a total of z) battery cells 450 in the battery pack 410 is estimated based on the inputted temperatures T(1) to T(K) from the temperature sensors 441 to 44K (step S710). According to the present embodiment, assuming that the temperature sensors 441 to 44K and the battery modules 40x are arranged, a cell temperature estimation map is stored in the ROM 54 for estimating the cell temperatures Tcel(z) of all the battery cells 450 from the temperatures T(1) to T(K) detected by the temperature sensors 441 to 44K. In step S710, the cell temperature Tcel(z) of the individual battery cell 450 is derived using the cell temperature estimation map and inputted temperatures T(1) to T(K). A distribution pattern of the cell temperature Tcel(z) of the individual battery cell 450 estimated in this way is illustrated in FIG. 10. After the temperature Tcel(z) of the individual battery cell 450 is estimated, the reference internal resistance of the individual battery cell 450 is obtained based on the estimated cell temperatures Tcel(1) to Tcel(Z) (step S720). According to the present embodiment, the relation between the cell temperature Tcel(z) and the reference internal resistance Rrc(z) of the individual battery cell 450 is determined in advance and is stored in the ROM 54 as the reference internal resistance derivation map. As the reference internal resistance Rrc(z), a value corresponding to a given cell temperature Tcel(z) is derived from the map. It should be noted that the reference internal resistance derivation map used in step S720 is the same as the reference internal resistance derivation map of FIG. 5 used in the first embodiment.

Subsequently, the variable x indicating the number of a battery module 40x in the battery pack 410 is incremented by 1 (step S730). For the xth battery module 40x in the battery pack 410, a reference internal resistance Rrm(x) is calculated by obtaining a total, sum of the reference internal resistances Rrc(z) of the battery cells 450 contained in the battery module 40x acquired in step S720 (step S740). Further, for the xth battery module 40x, a calculation is made to obtain the detected internal resistance Rdm(x) indicating the internal resistance of the battery module 40x based on the detected voltage V(x) and the detected current value I (step S750). The calculation of the detected internal resistance Rdm(x) in step S750 is performed in the same way as the process in step S170 of the FIG. 3 using the above expression (1). After, for the xth battery module 40x, the reference internal resistance Rrm(x) and the detected internal resistance Rdm(x) are obtained in this way, a calculation is made to obtain the resistance difference dR indicating a degree of difference between the reference internal resistance Rrm(x) and the detected internal resistance Rdm(x) (step S760). The calculation of the resistance difference dR in step S760 is performed in the same way as the process in step S180 of the FIG. 3 using the above expression (2). Subsequently, a determination is made to see whether the resistance difference dR is equal to or less than a threshold drref (step S770). If the resistance difference dR is equal to or less than the threshold dRref, a determination is made that the xth battery module 40x in the battery pack 410 does not have an abnormal cell (step S780); and if the resistance difference dR is greater than the threshold dRref, a determination is made that the xth battery module 40x has an abnormal cell and an alarm indicating that the battery module 40x has an abnormal cell is displayed on an instrument panel (not shown) (step S790). Following the step S780 or S790, a determination is made to see whether the variable x matches the number of modules X in the battery pack 410 (step S800). If the variable x does not match the number of modules X, the above described processes in steps S730 to S780 or to S790 are repeated until the variable x matches the number of modules X. Thereby, the presence or absence of an abnormal cell can be determined in all the battery modules 40x. When variable x matches the number of modules X, the routine is terminated.

As described above, according to the high-voltage battery unit 400C serving as the battery apparatus in accordance with the third embodiment, the reference internal resistance Rrc(z) indicating the internal resistance of the battery cell 450 based on the correlation to the temperature is estimated based on the temperatures T (1) to T (K) detected by the temperature sensors 441 to 44K (step S720); the detected internal resistance Rdm(x) indicating the internal resistance is acquired based on the detected voltage V(x) and the detected current value I for each the individual battery module 40x (step S750); and a failure of the battery cell 450, namely, the presence or absence of an abnormal cell in the individual battery module 40x is determined based on the acquired reference internal resistance Rrc(z) and the detected internal resistance Rdm(x) is determined (steps S760 to S780). Like this, the reference internal resistance Rrc(z) of the battery cell 450 is estimated based on the temperatures T(1) to T(K) detected by a plurality of temperature sensors 441 to 44K; a comparison is made between the estimated reference internal resistance Rrc(z) and the detected internal resistance Rdm(x); this comparison can eliminate the need to install a temperature sensor in every battery cell 450; and thus a smaller number of temperature sensors 441 to 44K can be used to accurately determine a failure of the battery cell 450 having an internal resistance varying depending on the temperature. In addition, according to the present embodiment, the cell temperature Tcel(z) of the individual battery cell 450 is estimated based on the temperatures T (1) to T (K) detected by the plurality of temperature sensors 441 to 44K; the reference internal resistance Rrm(x) of the individual battery module 40x is calculated from the reference internal resistance Rrc(z) of the individual battery cell 450 based on the estimated cell temperature Tcel(z); and thus the reference internal resistance used for failure determination can be more proper and the failure determination accuracy of the battery cell 450 can be improved.

It should be noted that according to the above third embodiment, the reference internal resistance Rrm(x) and the detected internal resistance Rdm(x) are calculated in units of battery modules 40x, but the present invention is not restrictive to this. For example, the reference internal resistance Rrm(x) and the detected internal resistance Rdm(x) may be calculated in units of cell blocks composed of a smaller number of battery cells 450 than that of the battery cells 450 contained in a battery module 40x to determine the presence or absence of an abnormal cell for each of the cell block. In addition, according to the above third embodiment, the cell temperature Tcel(z) is estimated for each battery cell 450, but the present invention is not restrictive to this. For example, the temperature may be estimated for each battery module 40x (cell block) to obtain the reference internal resistance of the battery module 40x (cell block) based on the estimated temperature. Further, when the temperature of the battery cell 450 or the like is estimated, the information about the operating environment of the high-voltage battery unit 400 such as the outside air temperature To; the coolant temperature Tc; the coolant air volume Va; the fan driving time tf, and the after-start elapsed time t1 may be considered. In addition, it is obvious that the temperature sensor failure determination routine explained related to the first embodiment can be applied to the high-voltage battery unit 400C of the third embodiment.

Hereinabove, the embodiments of the present invention have been described, but the present invention is not restrictive to the above embodiments. It is obvious that various modifications can be made without departing from the spirit of the invention.

For example, the battery cell 450 may be configured as a nickel-metal hydride battery and other battery instead of a lithium secondary battery. In addition, the high-voltage battery units 400 to 400C are not restrictive to the serially connected battery cells 450, but may include parallel connected battery cells 450 or battery modules 40x or may include a plurality of battery modules 40x which are configured by connecting the serially connected battery modules 40x in parallel.

In addition, the high-voltage battery units 400 to 400C in accordance with the individual embodiment are to be mounted in a hybrid vehicle 20, but may be mounted in an ordinary automobile other than the hybrid vehicle 20, a vehicle other than an automobile, and other mobile body such as boats, ships, vessels, and airplanes. In addition, the high-voltage battery units 400 to 400C may be built in fixed equipment such as a construction facility.

1. A battery apparatus including a plurality of battery cells each having an internal resistance varying depending on a temperature, said battery apparatus comprising:
a plurality of temperature detection devices arranged for said plurality of battery cells;
a voltage detection device for detecting a voltage of each of a plural cell blocks each composed of at least one said battery cell;
a current detection device for detecting a current flowing through each of said cell blocks;
a detected internal resistance acquisition module for acquiring a detected internal resistance indicating an internal resistance of said cell block based on said detected voltage and said detected current;
a reference internal resistance acquisition module for acquiring a reference internal resistance indicating an internal resistance of said battery cell based on a correlation to a temperature in each of a plurality of areas grouped so as to contain at least one said battery cell and one said temperature detection device according to a predetermined constraint, based on the temperature detected by any one of the temperature detection devices in said area; and
a failure determination module for determining a failure of said battery cell based on said acquired detected internal resistance and said acquired reference internal resistance.

2. A battery apparatus according to claim 1, wherein said predetermined constraint is a constraint based on a temperature distribution in said plurality of battery cells for grouping said plurality of battery cells into areas so as to contain said battery cell in an isothermal region within one said area.

3. A battery apparatus according to claim 1, further comprising:
a temperature distribution pattern storage for storing a plurality of temperature distribution patterns in said plurality of battery cells according to an operating environment of said battery apparatus as said predetermined constraint; and
an environmental information acquisition module for acquiring environmental information related to said operating environment;
wherein said reference internal resistance acquisition module, based on a temperature distribution pattern corresponding to said acquired environmental information in said temperature distribution patterns stored in said temperature distribution pattern storage, identifies
a plurality of said temperature detection devices used for failure determination of said battery cell and said cell blocks contained in the areas corresponding to said plurality of temperature detection devices used for failure determination of said battery cell; and acquires the reference internal resistance of said cell block of each of said areas.

4. A battery apparatus according to claim 1, further comprising:
a battery representative temperature detection device for detecting a representative temperature of said battery apparatus; and
a module for determining a failure of said temperature detection device by comparing between a temperature detected by said temperature detection device and a temperature detected by said battery representative temperature detection module.

5. A battery apparatus according to claim 1, further comprising:
a temperature distribution estimation module for estimating a temperature distribution in said plurality of battery cells based on an operating state of said battery apparatus; and
a module for determining a failure of said temperature detection module based on a temperature detected by said temperature detection module and said estimated temperature distribution.

6. A battery apparatus according to claim 1, wherein said battery cell is configured as a lithium secondary battery or a nickel-metal hydride battery.

7. A vehicle with a battery apparatus mounted thereon, said battery apparatus including a plurality of battery cells each having an internal resistance varying depending on a temperature, said vehicle comprising:
a plurality of temperature detection devices arranged for said plurality of battery cells;
a voltage detection device for detecting a voltage of each of a plural cell blocks each composed of at least one said battery cell;
a current detection device for detecting a current flowing through each of said cell blocks;
a detected internal resistance acquisition module for acquiring a detected internal resistance indicating an internal resistance of said cell block based on said detected voltage and said detected current;
a reference internal resistance acquisition module for acquiring a reference internal resistance indicating an internal resistance of said battery cell based on a correlation to a temperature in each of the plurality of areas grouped so as to contain at least one said battery cell and one said temperature detection device according to a predetermined constraint, based on the temperature detected by any one of the temperature detection devices in said area; and
a failure determination module for determining a failure of said battery cell based on said acquired detected internal resistance and said acquired reference internal resistance.

8. A battery apparatus including a plurality of battery cells each having an internal resistance varying depending on a temperature, said battery apparatus comprising:
a plurality of temperature detection devices arranged for said plurality of battery cells;
a voltage detection device for detecting a voltage of each of a plural cell blocks each composed of at least one said battery cell;
a current detection device for detecting a current flowing through each of said cell blocks;
a detected internal resistance acquisition module for acquiring a detected internal resistance indicating an internal resistance of said cell block based on said detected voltage and said detected current;
a reference internal resistance estimation module for estimating a reference internal resistance indicating an internal resistance of said battery cell based on a correlation to a temperature, based on the temperature detected by said plurality of temperature detection devices; and
a failure determination module determining a failure of said battery cell based on said acquired detected internal resistance and said estimated reference internal resistance.

9. A battery apparatus according to claim 8, wherein said cell block is composed of a serially connected plurality of said battery cells;
wherein said reference internal resistance estimation module estimates a temperature of each of said battery cells based on the temperature detected by said plurality of temperature detection devices, acquires the reference internal resistance of each of said battery cells based on said estimated temperature, and calculates the reference internal resistance of each of said cell blocks based on the acquired reference internal resistance of said battery cell; and
wherein said failure determination module determines the presence or absence of an abnormal cell in each of said cell blocks based on said acquired detected internal resistance and said calculated reference internal resistance of said cell block.

10. A battery apparatus according to claim 8, further comprising:
a battery representative temperature detection device for detecting a representative temperature of said battery apparatus; and
a module for determining a failure of said temperature detection device by comparing between a temperature detected by said temperature detection device and a temperature detected by said battery representative temperature detection module.

11. A battery apparatus according to claim 8, further comprising:
a temperature distribution estimation module for estimating a temperature distribution in said plurality of battery cells based on an operating state of said battery apparatus; and
a module for determining a failure of said temperature detection module based on a temperature detected by said temperature detection module and said estimated temperature distribution.

12. A battery apparatus according to claim 8, wherein said battery cell is configured as a lithium secondary battery or a nickel-metal hydride battery.

13. A vehicle with a battery apparatus mounted thereon, said battery apparatus including a plurality of battery cells each having an internal resistance varying depending on a temperature, said vehicle comprising:
a plurality of temperature detection devices arranged for said plurality of battery cells;
a voltage detection device for detecting a voltage of each of a plural cell blocks each composed of at least one said battery cell;
a current detection device for detecting a current flowing through each of said cell blocks;
a detected internal resistance acquisition module for acquiring a detected internal resistance indicating an internal resistance of said cell block based on said detected voltage and said detected current;
a reference internal resistance estimation module for estimating a reference internal resistance indicating an internal resistance of said battery cell based on a correlation to a temperature, based on the temperature detected by said plurality of temperature detection devices; and
a failure determination module determining a failure of said battery cell based on said acquired detected internal resistance and said estimated reference internal resistance.

14. A battery apparatus including a plurality of battery cells each having an internal resistance varying depending on a temperature, said battery apparatus comprising:
a voltage detection device for detecting voltages of each of a plural cell blocks each composed of the same number of said battery cells; and
a failure determination module for determining a failure of said battery cell by comparing said detected voltages between at least two cell blocks considered to be in an isothermal region.

15. A battery apparatus according to claim 14, wherein
said failure determination module determines a failure of said battery cell by comparing said detected voltages between at least two said cell blocks for each of a plurality of areas grouped so as to contain said at least two cell blocks considered to be in an individual isothermal region.

16. A battery apparatus according to claim 14, further comprising:
a battery representative temperature detection device for detecting a representative temperature of said battery apparatus; and
a module for determining a failure of said temperature detection device by comparing between a temperature detected by said temperature detection device and a temperature detected by said battery representative temperature detection module.

17. A battery apparatus according to claim 14, further comprising:
a temperature distribution estimation module for estimating a temperature distribution in said plurality of battery cells based on an operating state of said battery apparatus; and
a module for determining a failure of said temperature detection module based on a temperature detected by said temperature detection module and said estimated temperature distribution.

18. A battery apparatus according to claim 14, wherein said battery cell is configured as a lithium secondary battery or a nickel-metal hydride battery.

19. A vehicle with a battery apparatus mounted thereon, said battery apparatus having a plurality of battery cells each having an internal resistance varying depending on a temperature, said vehicle comprising:
a voltage detection device for detecting voltages of each of a plural cell blocks each composed of the same number of said battery cells; and
a failure determination module for determining a failure of said battery cell by comparing said detected voltages between at least two cell blocks considered to be in an isothermal region.

20. A failure determination method for a battery apparatus including a plurality of battery cells each having an internal resistance varying depending on a temperature, and a plurality of temperature detection devices arranged for said plurality of battery cells, said failure determination method comprising the steps of:
(a) acquiring a detected internal resistance indicating an internal resistance of a cell block composed of at least one said battery cell based on a voltage of said cell block and a current flowing through said cell block;
(b) acquiring a reference internal resistance indicating an internal resistance of said battery cell based on a correlation to a temperature in each of a plurality of areas grouped so as to contain at least one said battery cell and one said temperature detection device according to a predetermined constraint, based on the temperature detected by any one of the temperature detection device in said area; and
(c) determining a failure of said battery cell based on the detected internal resistance acquired in step (a) and the reference internal resistance acquired in step (b).

21. A failure determination method for a battery apparatus according to claim 20, wherein said predetermined constraint is a constraint based on a temperature distribution in said plurality of battery cells for grouping said plurality of battery cells into areas so as to contain said battery cell in an isothermal region within one said area.

22. A failure determination method for a battery apparatus according to claim 20, wherein
said battery apparatus further comprises a temperature distribution pattern storage for storing a plurality of temperature distribution patterns in said plurality of battery cells according to an operating environment of said battery apparatus as said predetermined constraint; and an environmental information acquisition module for acquiring environmental information related to said operating environment; and
wherein said step (b), based on a temperature distribution pattern corresponding to said acquired environmental information in said temperature distribution patterns stored in said temperature distribution pattern storage, identifies a plurality of said temperature detection devices used for failure determination of said battery cell and said cell blocks contained in the areas corresponding to said plurality of temperature detection devices used for failure determination of said battery cell; and acquires the reference internal resistance of said cell block of each of said areas.

23. A failure determination method for a battery apparatus including a plurality of battery cells each having an internal resistance varying depending on a temperature, and a plurality of temperature detection devices arranged for said plurality of battery cells, said failure determination method comprising the steps of:
(a) acquiring a detected internal resistance indicating an internal resistance of a cell block composed of at least one said battery cell based on a voltage of said cell block and a current flowing through said cell block;
(b) acquiring a reference internal resistance indicating an internal resistance of said battery cell based on a correlation to a temperature, based on the temperatures detected by said plurality of temperature detection devices; and
(c) determining a failure of said battery cell based on the detected internal resistance acquired in step (a) and the reference internal resistance acquired in step (b).

24. A failure determination method for a battery apparatus according to claim 23, wherein
said cell block is composed of a serially connected plurality of said battery cells;
wherein said step (b) estimates a temperature of each of said battery cells based on the temperature detected by said plurality of temperature detection devices, acquires the reference internal resistance of each of said battery cells based on said estimated temperature, and calculates the reference internal resistance of each of said cell blocks based on the acquired reference internal resistance of said battery cell; and
wherein said step (c) determines the presence or absence of an abnormal cell in each of said cell blocks based on the detected internal resistance acquired in step (a) and the reference internal resistance of said cell block acquired in step (b).

25. A failure determination method for a battery apparatus including a plurality of battery cells each having an internal resistance varying depending on a temperature, said failure determination method comprising the steps of:
(a) detecting voltages of each of a plural cell blocks each composed of the same number of said battery cells; and
(b) determining a failure of said battery cell by comparing the voltages detected in step (a) between at least two cell blocks considered to be in an isothermal region.

26. A failure determination method for a battery apparatus according to claim 25, wherein
said step (b) determines a failure of said battery cell by comparing said detected voltages between at least two said cell blocks for each of a plurality of areas grouped so as to contain said at least two cell blocks considered to be in an individual isothermal region.
